(19) United States
(12) Patent Application Publication
(10) Pub. No.: US 2011/0113786 A1
(43) Pub. Date: May 19, 2011

(54) COMBINED CYCLE POWER PLANT WITH INTEGRATED ORGANIC RANKINE CYCLE DEVICE

(75) Inventors: Diego Fernando Rancruel, Mauldin, SC (US); Jatila Ranasinghe, Simpsonville, SC (US)

(73) Assignee: GENERAL ELECTRIC COMPANY, Schenectady, NY (US)

(21) Appl. No.: 12/621,073

(22) Filed: Nov. 18, 2009

(51) Int. Cl. F02C 6/04; F01K 23/06; F01K 25/00

(52) U.S. Cl. 60/772; 60/39.181; 60/643

(57) ABSTRACT

A combined cycle power plant includes a gas turbomachine having a compressor portion and a turbine portion, a heat recovery steam generator (HRSG) operatively coupled to the turbine portion of the gas turbomachine, and an organic Rankine cycle (ORC) device fluidly coupled to the HRSG. The ORC device includes an organic fluid passing through a closed loop system operatively coupled to a turbine. Heated fluid from the HRSG elevates a temperature of the organic fluid flowing through the closed loop system. Thermal energy from the organic fluid is converted to mechanical energy in the turbine.

### BACKGROUND OF THE INVENTION

The subject matter disclosed herein relates to combined cycle power plants and, more particularly, to a combined cycle power plant having an integrated Organic Rankin Cycle device.

In a combined cycle power plant (CCPP), a gas turbine drives a generator, which produces electricity. Waste heat from the gas turbine is used to generate steam in a heat recovery steam generator (HRSG), which, in turn, is used to generate additional electricity via a steam turbine. More specifically, a combined cycle is characteristic of a power producing engine or plant that employs more than one thermodynamic cycle. Heat engines, such as gas turbines, are only able to use a portion of the energy their fuel generates (usually less than 50%). Any remaining heat (e.g. hot exhaust fumes) from combustion is generally wasted. Combining two or more “cycles” such as a Brayton cycle (Gas) and a Rankine Cycle (Steam) results in improved output efficiency.

An Organic Rankine Cycle (ORC) is similar to the cycle of a conventional steam turbine, except for the fluid that drives the turbine. In place of steam, the ORC employs a high molecular mass organic fluid. Some of the chemicals used in ORC's are Freon, butane, propane, ammonia, as well as many new environmentally friendly refrigerants. The selected working fluids allow system designers to exploit low temperature heat sources to produce electricity in a wide range of power outputs (from few kW up to 3 MW electric power per unit). For that reason, ORC's find wide use in geothermic heat pump systems. In a typical ORC the organic working fluid is vaporized by application of the heat source in an evaporator (ORC-EVA). The organic fluid vapor expands in a turbine (ORC-TUR) and then condensed using a flow of water in a condenser (ORC-CON) (alternatively, ambient air can be used for cooling). The condensed fluid is pumped back to the evaporator thus closing the thermodynamic cycle.

### BRIEF DESCRIPTION OF THE INVENTION

According to one aspect of the exemplary embodiment, a combined cycle power plant includes a gas turbomachine having a compressor portion and a turbine portion, a heat recovery steam generator (HRSG) operatively coupled to the turbine portion of the gas turbomachine, and an organic Rankine cycle (ORC) device fluidly coupled to the HRSG. The ORC device includes an organic fluid passing through a closed loop system operatively coupled to a turbine. Heated fluid from the HRSG elevates a temperature of the organic fluid flowing through the closed loop system. Thermal energy from the organic fluid is converted to mechanical energy in the turbine.

According to another aspect of the exemplary embodiment, a method of operating a combined cycle power plant includes operating a gas turbomachine including a compressor portion and a turbine portion, passing hot gases from the turbine portion through a heat recovery steam generator (HRSG), transferring heat from the hot gases to a fluid passing through the HRSG to form heated fluid, passing the heated fluid to an organic Rankine Cycle (ORC) device having a closed loop organic fluid system, transferring heat from the heated fluid to organic fluid flowing through the closed loop organic fluid system in the ORC device to form heated organic vapor having thermodynamic energy, and converting the thermodynamic energy in the heated organic vapor to mechanical energy in a turbine operatively coupled to the closed loop system.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic view of a combined cycle power plant including an integrated organic Rankine cycle device in accordance with an exemplary embodiment;

FIG. 2 is a schematic view of a combined cycle power plant including an integrated organic Rankine cycle device in accordance with another aspect of the exemplary embodiment; and

FIG. 3 is a schematic view of a combined cycle power plant including an integrated organic Rankine cycle device in accordance with yet another aspect of the exemplary embodiment.

The detailed description explains embodiments of the invention, together with advantages and features, by way of example with reference to the drawings.

### DETAILED DESCRIPTION OF THE INVENTION

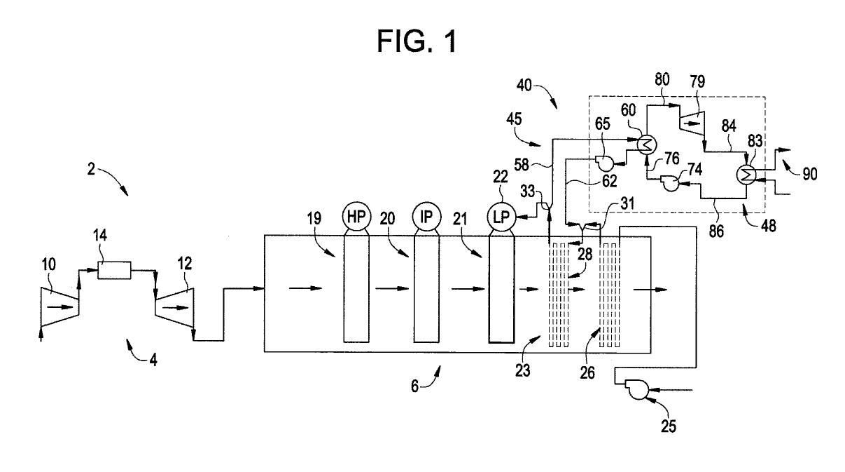

With reference FIG. 1, the combined cycle power plant constructed in accordance with an exemplary embodiment is indicated generally at 2. Power plant 2 includes a gas turbomachine 4 operatively linked to a heat recovery steam generator (HRSG) 6. Gas turbomachine 4 includes a compressor portion 10 linked to a turbine portion 12 via a combustor portion 14. HRSG 6 includes a high pressure (HP) portion 19, and intermediate (IP) portion 20 and a low pressure (LP) portion 21 having a low pressure drum 22. HRSG 6 is also shown to include an economizer 23 operatively linked to LP portion 21. Economizer 23 is fluidly connected to a feed pump 26 that supplies heated fluid to HRSG 6. Economizer 23, in accordance with an exemplary embodiment, includes a first economizer portion 26 fluidly linked to a second economizer portion 28 via a first junction point 31. Second economizer portion 28 is linked to low pressure drum 22 via a second junction point 33. In further accordance with the exemplary embodiment shown, combined cycle power plant 2 includes an organic ranking cycle (ORC) device 40.

In accordance with an exemplary embodiment, organic Rankine cycle device 40 includes a first fluid system 45 that is arranged in a heat exchange relationship with a second, closed loop, fluid system 48. First fluid system 45 includes a supply conduit 58 that is operatively linked between second junction point 33 and an evaporator 60 that is integrated with second fluid system 48. A return conduit 62 passes from evaporator 60, through a pump 65, and back to first junction point 31. As will be discussed more fully below, fluid passing through first fluid system 45 is in a heat exchange relationship with an organic fluid that passes through second fluid system 48.

In further accordance with the embodiment shown, second fluid system 48 includes a pump 74 that is fluidly connected to evaporator 60 via a conduit 76. Evaporator 60 is, in turn, linked to a turbine 79 via a conduit 80. Turbine 79 is linked to a condenser 83 via a conduit 84. Condenser 83 is linked to pump 74 via a conduit 86 thereby closing second fluid system 48. Condenser 83 includes a cooling fluid circuit 90 that is coupled to a cooling device (not shown). Of course it should be understood that the particular type of cooling device can vary and could include water cooling, air cooled condensers, and the like. More specifically, pump 74 pressurizes the organic fluid flowing through second fluid system 48. The pressurized fluid passes through evaporator 60 and exchanges heat with fluid passing through first fluid system 45. The heated organic fluid passes through conduit 80 to turbine 79. Work is extracted from the heated fluid in turbine 79 and converted to, for example, mechanical energy that is employed to operate a mechanical device such as a generator, a water pump, an oil pump, an air compressor or the like (not shown). The heated organic fluid then passes to condenser 83 via conduit 84. At this point, cooling fluid coming from the cooling tower exchanges heat with the organic fluid. The organic fluid, now at a lower temperature, returns to pump 74 to restart the heat exchange cycle. At this point it should be understood that the location of various junction points in the exemplary embodiment could vary in accordance with an exemplary embodiment. For example, first junction point 31 is located at a position where exit temperature of economizer 26 is substantially similar to the temperature of fluid flowing through conduit 62.

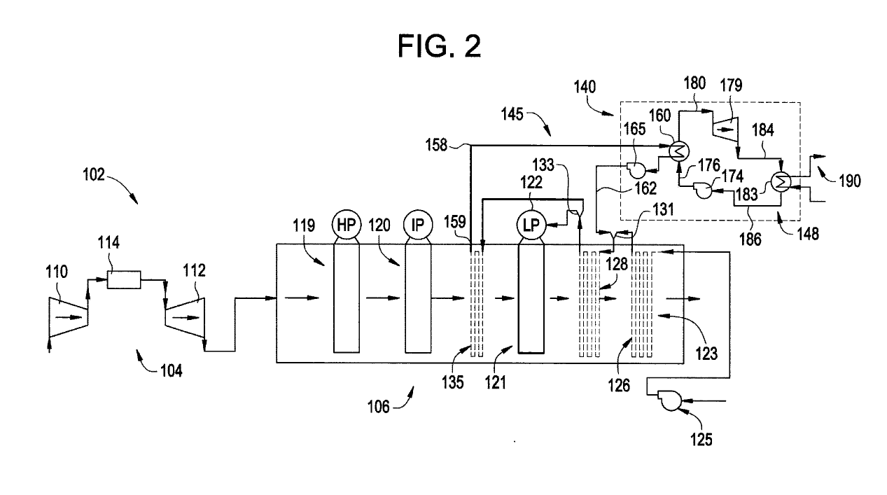

Reference will now be made to FIG. 2 in describing a combined cycle power plant 102 constructed in accordance with another exemplary embodiment of the invention. Combined cycle power plant 102 includes a gas turbomachine 104 operatively linked to an HRSG 106. Gas turbomachine 104 includes a compressor portion 110 operatively linked to a turbine portion 112 via a combustor portion 114. HRSG 106 includes an HP portion 119, an IP portion 120 and an LP portion 121 having a low pressure drum 122. Low pressure portion 121 is also shown to include an economizer 123 that is fluidly coupled to a feed pump 125 that delivers heated fluid to LP portion 121. Economizer 123 includes a first economizer portion 126 fluidly linked to a second economizer portion 128 via a first junction point 131. Second economizer portion 128 is linked to low pressure drum 122 via a second junction point 133. In addition, HRSG 106 includes an IP economizer 135 fluidly linked to second junction point 133. In accordance with the exemplary embodiment shown, combined cycle power plant 102 includes an Organic Rankine Cycle device 140 operatively coupled to HRSG 106.

Organic Rankine Cycle device 140 includes a first fluid system 145 that is in a heat exchange relationship with a second, closed loop, fluid system 148. A supply conduit 158 extends between an outlet 159 of IP economizer 135 and an evaporator 160 that is integrated with second fluid system 148. A return conduit 162 extends from evaporator 160, to a pump 165, and then to first junction point 131. In a manner similar to that described above, heat entrained within the fluid passing through first fluid system 145 is exchanged with an organic fluid flowing through second fluid system 148 at evaporator 160.

Second fluid system 148 includes a pump 174 that is fluidly connected to evaporator 160 via a conduit 176. Evaporator 160 is also fluidly connected to a turbine 179 via a conduit 180. Turbine 179 is fluidly connected to a condenser 183 via a conduit 184. Condenser 183 is then fluidly connected to pump 174 via a conduit 186 thereby closing the second fluid system 148. Condenser 183 is also coupled to a cooling fluid circuit 190, which, in manner similar to that described above, is linked to a cooling device (not shown). Of course it should be understood that the particular type of cooling device can vary and could include water cooling, air cooled condensers, and the like. More specifically, pump 174 pressurizes the organic fluid flowing through second fluid system 148. The pressurized fluid passes through evaporator 160 and exchanges heat with fluid passing through first fluid system 145. The heated organic fluid passes through conduit 180 to turbine 179. Work is extracted from the heated fluid in turbine 179 and converted to, for example, mechanical energy that is employed to operate a mechanical device such as a generator, a water pump, an oil pump, an air compressor or the like (not shown). The heated organic fluid then passes to condenser 183 via conduit 184. At this point, cooling fluid coming from the cooling tower exchanges heat with the organic fluid. The organic fluid, now at a lower temperature, returns to pump 174 to restart the heat exchange cycle. At this point it should be understood that the location of various junction points in the exemplary embodiment could vary in accordance with an exemplary embodiment. That is, first junction point 131 could be located directly adjacent an inlet of economizer 126, adjacent an exit of economizer 128 or anywhere in-between.

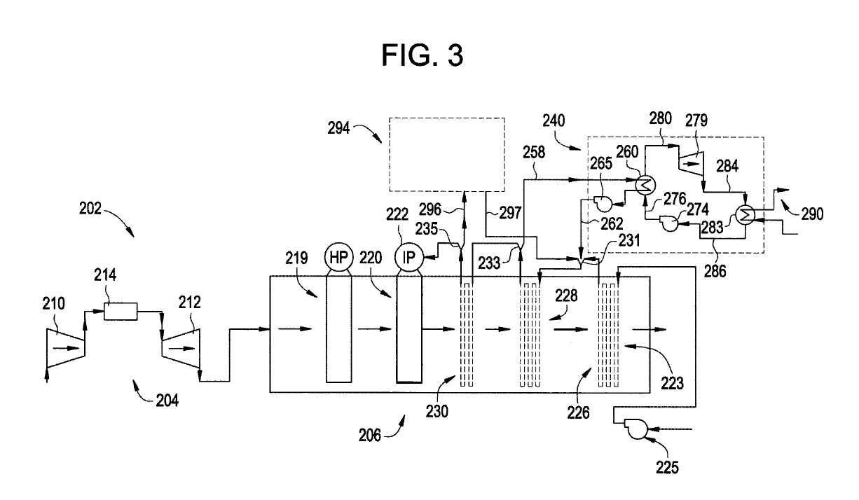

Reference will now be made to FIG. 3 in describing a combined cycle power plant 202 constructed in accordance with yet another exemplary embodiment. Combined cycle power plant 102 includes a gas turbomachine 204 that is operatively linked to an HRSG 206. Gas turbomachine 204 includes a compressor portion 210 operatively linked to a turbine portion 212 via a combustor portion 214. HRSG 206 includes an HP portion 219, and an IP portion 220 having an IP pressure drum 222. HRSG 206 is also shown to include an economizer 223 fluidly connected to a feed pump 225 that delivers heated fluid to IP portion 220. Economizer 223 includes a first economizer portion 226, a second economizer portion 228, and a third economizer portion 230. First economizer portion 226 is linked to second economizer portion 228 via a first junction point 231, while second economizer portion 228 is linked to third economizer portion 230 via a second junction point 233. A third junction point 235 links third economizer portion 230 with IP drum 222. In a manner similar to that described above, combined cycle power plant 202 includes an Organic Rankine Cycle device 240 that is fluidly connected to HRSG 206.

Organic Rankine Cycle device 240 includes a first fluid system 245 that is in a heat exchange relationship with a second, closed loop, fluid system 248. A supply conduit 258 extends from second junction point 233 to an evaporator 260 that is integrated with second fluid system 248. A return conduit 262 leads from a pump 265 back to first junction point 231. With this arrangement, heat entrained within fluid passing through first fluid system 145 is exchanged with an organic fluid flowing through second fluid system 248 in a manner that will be described more fully below.

Second fluid system 248 includes a pump 274 that is fluidly connected to evaporator 260 via a conduit 276. Evaporator 260 is, in turn, fluidly linked to a turbine 279 via a conduit 280. Turbine 279 is linked to a condenser 283 via a conduit 284. Condenser 283 is fluidly connected to pump 274 via a conduit 286 thereby closing second fluid system 248. Condenser 283 is in a heat exchange relationship with a cooling fluid circuit 290, which, in a manner similar to that described above, is linked to a cooling device (not shown). Of course it should be understood that the particular type of cooling device can vary and could include water cooling, air cooled condensers, and the like. In further accordance with the exemplary embodiment, combined cycle power plant 102 includes a fuel moisturization system 294 operatively coupled to HRSG 206. More specifically, fuel moisturization system 294 includes a first conduit 296 that is coupled to third junction point 235 and a second conduit 297 that is coupled to first junction point 231.

With this arrangement, pump 174 pressurizes the organic fluid flowing through second fluid system 148. The pressurized fluid passes through evaporator 160 and exchanges heat with fluid passing through first fluid system 145. The heated organic fluid passes through conduit 180 to turbine 179. Work is extracted from the heated fluid in turbine 179 and converted to, for example, mechanical energy that is employed to operate a mechanical device such as a generator, a water pump, an oil pump, an air compressor or the like (not shown). The heated organic fluid then passes to condenser 183 via conduit 184. At this point, cooling fluid coming from the cooling tower exchanges heat with the organic fluid. The organic fluid, now at a lower temperature, returns to pump 174 to restart the heat exchange cycle. Fuel moisturization system 294 saturates a dry-fuel supply to turbomachine 204 in a manner known in the art.

At this point it should be understood that the location of the various connection points illustrated in FIG. 3 could vary in accordance with an exemplary embodiment. For example, the location of first junction point 231 could vary. That is, conduit 262 could also connect to an inlet of economizer 226. Similarly, conduit 297 can be coupled to an inlet of economizer 226 or to junction 233. Likewise, the location of second junction point 233 could vary. That is, second junction point could be located directly adjacent an inlet of economizer 228, adjacent an exit of economizer 230 or anywhere therebetween. Also, the location of third junction point 235 could vary. That is, conduit 296 could extend from second junction point 233 and conduit 297 could be coupled to economizer 226 or to second junction 233. It should also be understood that the exemplary embodiments could be implemented in various types of ORC devices and should not be limited to any particular ORC configuration or the exemplary ORC configurations shown and described herein.

With this arrangement, the exemplary embodiments take enhance energy extraction efficiencies associated with low temperature systems such as those employed in geothermal applications. That is, in contrast to lower efficiency steam systems the exemplary embodiment employs an Organic Rankine Cycle Device to enhance efficiencies associated with converting heat energy flowing through the low pressure economizer produced from, for example, a geothermal heat exchange system to power other systems such as, generators. Organic Rankine Devices typically have an elevated turbine efficiency, realize low mechanical stress on the turbine due to low peripheral speeds; provide low rpm output of the turbine thereby allowing direct drive of associated components such as generators without the need for additional costly components such as reduction drives; and realize low maintenance costs. That is, the absence of moisture in the organic Rankine cycle enhances turbine blade life. Without moisture, turbine blades tend not to wear or show erosion characteristics associated with steam systems.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A combined cycle power plant comprising:
a gas turbomachine including a compressor portion and a turbine portion;
a heat recovery steam generator (HRSG) operatively coupled to the turbine portion of the gas turbomachine; and
an organic Rankine cycle (ORC) device fluidly coupled to the heat recovery steam generator, the ORC device including an organic fluid passing through a closed loop system operatively coupled to a turbine, wherein heated fluid from the HRSG elevates a temperature of the organic fluid passing through the closed loop system, thermal energy from the organic fluid is converted to mechanical energy in the turbine.

2. The combined cycle power plant of claim 1, wherein the HRSG includes at least one economizer.

3. The combined cycle power plant according to claim 2, wherein the at least one economizer comprises at least one low pressure economizer, the ORC device being fluidly coupled to the at least one low pressure economizer.

4. The combined cycle power plant according to claim 2, wherein the HRSG includes a low pressure drum fluidly linked to the at last one low pressure economizer, the ORC device being fluidly connected to each of the low pressure economizer and the low pressure drum.

5. The combined cycle power plant according to claim 4, wherein the at least one low pressure economizer includes a first low pressure economizer and a second low pressure economizer, the ORC device being fluidly connected between the first and second low pressure economizers and the low pressure drum.

6. The combined cycle power plant according to claim 2, wherein the at least one economizer includes a low pressure economizer and an intermediate pressure economizer, the ORC being fluidly connected between the low pressure economizer and the intermediate pressure economizer.

7. The combined cycle power plant according to claim 2, wherein the at least one economizer comprises at least one an intermediate pressure economizer, the ORC device being fluidly coupled to the at least one intermediate pressure economizer.

8. The combined cycle power plant according to claim 7, wherein the at least one intermediate pressure economizer includes a first intermediate pressure economizer, a second intermediate pressure economizer, and a third intermediate pressure economizer.

9. The combined cycle power plant according to claim 8, wherein the ORC device is fluidly coupled between an outlet of the first intermediate pressure economizer and an outlet of the third intermediate pressure economizer.

10. The combined cycle power plant according to claim 9, further comprising: a fuel moisturization system (FMS) fluidly coupled to the ORC device.

11. The combined cycle power plant according to claim 10, wherein the FMS is fluidly connected between the outlet of the first intermediate pressure economizer and an outlet of the third intermediate pressure economizer.

12. A method of operating a combined cycle power plant, the method comprising:
operating a gas turbomachine including a compressor portion and a turbine portion;
passing hot gases from the turbine through a heat recovery steam generator (HRSG);
transferring heat from the hot gases to a fluid passing through the HRSG to form heated fluid;
passing the heated fluid to an organic Rankine Cycle (ORC) device having a closed loop organic fluid system;
transferring heat from the heated fluid to organic fluid flowing through the closed loop organic fluid system in the ORC device to form heated organic vapor having thermodynamic energy; and
converting the thermodynamic energy in the heated organic vapor to mechanical energy in a turbine operatively coupled to the closed loop system.

13. The method of claim 12, further comprising:
passing the heated fluid through an evaporator in the ORC device to form the heated organic fluid.

14. The method of claim 13, further comprising:
passing the heated fluid from a low pressure portion of the HRSG to the evaporator.

15. The method of claim 14, further comprising:
passing the heated fluid from an outlet of a first low pressure economizer to the evaporator.

16. The method of claim 15, further comprising:
passing the liquid from the evaporator to a second low pressure economizer.

17. The method of claim 13, further comprising:
passing the heated fluid from an intermediate pressure economizer to the evaporator.

18. The method of claim 17, further comprising:
passing the heated fluid from an outlet of a third intermediation pressure economizer to the evaporator, the third intermediation pressure economizer being fluidly connected to an intermediate pressure drum.

19. The method of claim 18, further comprising:
passing the heated fluid from the evaporator to an inlet of a second intermediate pressure economizer, the second intermediation pressure economizer being arranged down stream of a first intermediation pressure economizer and upstream of the third intermediation pressure economizer.

20. The method of claim 18, further comprising:
passing fluid from the outlet of the third intermediation pressure economizer, through a fuel moisturization system to the inlet of the second intermediation pressure economizer, the fluid passing from the evaporator and the fluid passing from the fuel moisturization system being at substantially similar temperatures.
